(19) United States
(12) Patent Application Publication
(10) Pub. No.: US 2025/0264790 A1
(43) Pub. Date: Aug. 21, 2025

(54) ILLUMINATOR AND PROJECTOR

(71) Applicant: SEIKO EPSON CORPORATION, Tokyo (JP)

(72) Inventor: Noriyoshi HIROI, MATSUMOTO-SHI, NAGANO-KEN (JP)

(21) Appl. No.: 19/056,976

(22) Filed: Feb. 19, 2025

(30) Foreign Application Priority Data
Feb. 20, 2024 (JP) 2024-024103

(51) Int. Cl. G03B 21/20

(52) U.S. Cl. CPC G03B 21/204; G03B 21/2013; G03B 21/2066

(57) ABSTRACT

An illuminator according to an embodiment of the present disclosure includes a first light source configured to output first light having a first wavelength band; a second light source configured to output second light having a second wavelength band different from the first wavelength band; a light combiner having a first surface and a second surface different from the first surface; and a light receiving sensor configured to receive the first light and the second light. The light combiner includes a substrate, and a reflection film layered on the substrate. The reflection film has transmittance higher than reflectance in the first wavelength band, and the reflectance is higher than 0% in the first wavelength band. The reflection film has transmittance lower than the reflectance in the second wavelength band, and the transmittance is higher than 0% in the second wavelength band. The first light is incident on the first surface, and the second light is incident on the second surface. The light receiving sensor is configured to receive the first light reflected off the first surface and the second light passing through the second surface.

The present application is based on, and claims priority from JP Application Serial Number 2024-024103, filed Feb. 20, 2024, the disclosure of which is hereby incorporated by reference herein in its entirety.

### BACKGROUND

### 1. Technical Field

The present disclosure relates to an illuminator and a projector.

### 2. Related Art

There is a known projector including a light source that outputs color light, a light modulator that modulates the color light output from the light source in accordance with image information to generate image light, and a projection system that enlarges the image light output from the light modulator and projects the enlarged image light onto a projection receiving surface such as a screen. The projector includes a light source apparatus including, for example, a blue light source that outputs blue light, an excitation light source that is provided separately from the blue light source and outputs blue light, and a phosphor that is excited by the blue light output from the excitation light source to emit yellow light. In the thus configured projector, white light containing the blue light and the yellow light is output from the light source apparatus, and the multiple types of color light contained in the white light are converted into multiple types of image light by a common light modulator or light modulators disposed on a color light basis.

In the projector described above, a laser diode (LD) or a light emitting diode (LED) is, for example, used as each of the blue light source and the excitation light source. The luminance or intensity of the light output from each of the LDs or the LEDs of the light source apparatus vary in accordance with the period for which the projector and the light source apparatus are used, the temperature at which they are used, voltages applied thereto, and other factors. The variation in luminance or intensity of the light from the light source apparatus affects the color balance or the image quality of an image enlarged and projected onto the projection receiving surface. There has been a proposed configuration in which the luminance or intensity of part of the multiple types of color light output from the light source apparatus is detected, and the state or the degree of deterioration of each of the light sources in the projector is determined.

For example, JP-A-2016-114738 discloses a projector including a detection apparatus that detects the luminance of part of each of blue light and red light. In the projector disclosed in JP-A-2016-114738, red light and green light output from a first light source section and blue light output from a second light source section are superimposed on each other in the same optical path, and then separated by filters that each separate light having wavelengths within a preset range into the three types of color light that travel along different optical paths. The detection apparatus detects the luminance of the blue light having been separated by the corresponding filter so as to travel along the optical path for the blue light and then having passed through a reflection mirror, and detects the luminance of the red light having been separated by the corresponding filter so as to travel along the optical path different from the optical path of the blue light and then having passed through a reflection mirror. In the projector disclosed in JP-A-2016-114738, the color balance of a projection image is adjusted based on information relating to the luminance of the blue light and the luminance of the red light detected by the detection apparatus.

JP-A-2016-114738 is an example of the related art.

In the technology disclosed in JP-A-2016-114738 described above, since the detection apparatus is disposed at each of the reflection mirror through which part of the incident blue light passes and the reflection mirror through which part of the red light passes, there is a possibility of an increase in the size of the projector and complication of the configuration thereof. That is, it has been required to provide an illuminator that can detect information relating to the intensity of color light output from a light source and can have a small, simple configuration, and a projector including the illuminator.

### SUMMARY

An illuminator according to an aspect of the present disclosure includes a first light source configured to output first light having a first wavelength band; a second light source configured to output second light having a second wavelength band different from the first wavelength band; a light combiner having a first surface and a second surface different from the first surface; and a light receiving sensor configured to receive the first light and the second light. The light combiner includes a substrate, and a reflection film layered on the substrate. The reflection film has transmittance higher than reflectance in the first wavelength band, and the reflectance is higher than 0% in the first wavelength band. The reflection film has transmittance lower than the reflectance in the second wavelength band, and the transmittance is higher than 0% in the second wavelength band. The first light is incident on the first surface, and the second light is incident on the second surface. The light receiving sensor is configured to receive the first light reflected off the first surface and the second light passing through the second surface.

### BRIEF DESCRIPTION OF THE DRAWINGS

FIG. 1 is a schematic view of a projector according to a first embodiment.

FIG. 2 is a schematic view of an illuminator of the projector shown in FIG. 1.

FIG. 3 is a diagrammatic view relating to the transmittance and reflectance of a reflection film of a light combiner of the illuminator shown in FIG. 2.

FIG. 4 is a diagrammatic view relating to the transmittance and reflectance in a case where a reflection film of configured with a metal thin film is provided at the light combiner of the illuminator shown in FIG. 2.

FIG. 5 is a diagrammatic view relating to electric signals output from a light receiving sensor of the illuminator shown in FIG. 2.

FIG. 6 is a diagrammatic view relating to electric signals output from a light receiving sensor of an illuminator of related art.

FIG. 7 is a diagrammatic view of the spectrum of yellow light output from a light source of the illuminator shown in FIG. 2.

FIG. 8 is a schematic view showing an illuminator according to a second embodiment.

FIG. 9 is a schematic view showing an illuminator according to a third embodiment.

### DESCRIPTION OF EMBODIMENTS

Embodiments of the present disclosure will be described below with reference to the drawings. In the drawings, elements are drawn at different dimensional scales in some cases for clarity of each of the elements.

### First Embodiment

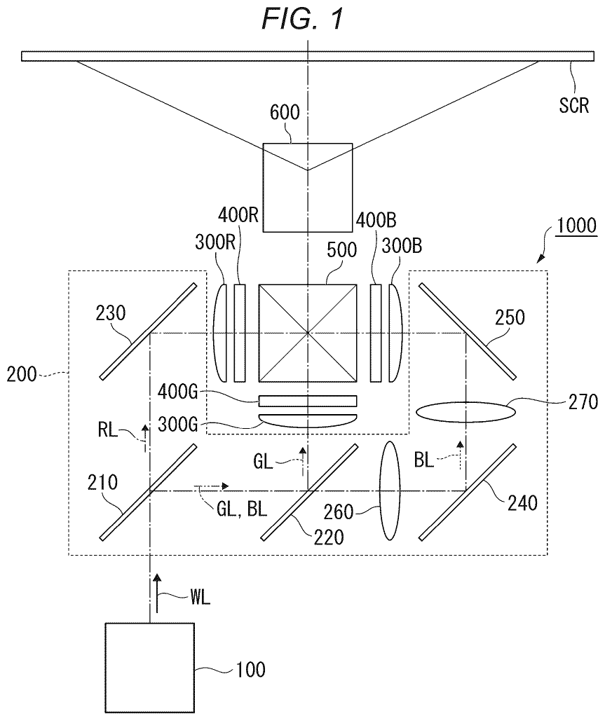

A first embodiment of the present disclosure will first be described with reference to FIGS. 1 to 7.

### Projector

FIG. 1 is a schematic view showing the configuration of a projector 1000 according to the first embodiment of the present disclosure. The projector 1000 is a projection-type display apparatus that displays an image and a video on a screen SCR. The projector 1000 includes an illuminator 100, a color separation system 200, field lenses 300R, 300G, and 300B, light modulators 400R, 400G, and 400B, a light combining system 500, and a projection system 600. The projector 1000 is a three-panel projector including three light modulators.

The illuminator 100 outputs white light WL, which contains blue light BL, green light GL, and red light RL, toward the color separation system 200. The red light RL, the green light GL, and the blue light BL form illumination light in the projector 1000. In the following description, at least one of the blue light BL, the green light GL, and the red light RL output from the illuminator 100 is referred to as color light in some cases. The configuration of the illuminator 100 will be described later.

The color separation system 200 separates the incident white light WL into the red light RL, the green light GL, and the blue light BL, and causes the three types of color light to travel along respective optical paths. The color separation system 200 includes, for example, dichroic mirrors 210 and 220, total reflection mirrors 230, 240, and 250, and relay lenses 260 and 270.

The dichroic mirror 210 is disposed in the optical path of the white light WL output from the illuminator 100. The dichroic mirror 210 transmits the red light RL and reflects the green light GL and the blue light BL. Out of the white light WL incident on the dichroic mirror 210, the red light RL and the combination of the green light GL and the blue light BL are separated from each other and caused to travel along optical paths different from each other. The red light RL passes through the dichroic mirror 210 and exits toward the total reflection mirror 230. The green light GL and the blue light BL are reflected off the dichroic mirror 210 and output toward the dichroic mirror 220.

The dichroic mirror 220 is disposed in the optical path common to the green light GL and the blue light BL output from the dichroic mirror 210. The dichroic mirror 220 transmits the blue light BL and reflects the green light GL. The green light GL and the blue light BL incident on the dichroic mirror 220 are separated from each other and caused to travel along optical paths different from each other. The green light GL is reflected off the dichroic mirror 220 and output toward the light modulator 400G. The blue light BL passes through the dichroic mirror 220 and exits toward the total reflection mirror 240.

The total reflection mirror 230 is disposed in the optical path of the red light RL output from the dichroic mirror 210, and reflects the incident red light RL toward the light modulator 400R. The total reflection mirror 240 is disposed in the optical path of the blue light BL output from the dichroic mirror 210, and reflects the incident blue light BL toward the total reflection mirror 250. The total reflection mirror 250 is disposed in the optical path of the blue light BL output from the total reflection mirror 240, and reflects the incident blue light BL toward the light modulator 400B.

The relay lens 260 is disposed in the optical path of the blue light BL between the dichroic mirror 220 and the total reflection mirror 240. The relay lens 270 is disposed in the optical path of the blue light BL between the total reflection mirror 240 and the total reflection mirror 250. The optical path length of the blue light BL from the dichroic mirror 210 to the light modulator 400B is longer than the optical path length of the red light RL from the dichroic mirror 210 to the light modulator 400R and the optical path length of the green light GL from the dichroic mirror 210 to the light modulator 400G. When no relay lenses are disposed in the optical path of the blue light BL, the optical loss of the blue light BL is greater than the optical loss of the red light RL and the green light GL. The aforementioned arrangement of the relay lenses 260 and 270 compensates for the optical loss of the blue light BL.

The field lens 300R is disposed in the optical path of the red light RL output from the total reflection mirror 230. The field lens 300R aligns the traveling directions of the incident red light RL in a peripheral region thereof and having an illuminance lower than a predetermined illuminance with one another in the plane that intersects with the optical axis of the red light RL to suppress a decrease in the amount of light in the peripheral region, and outputs the red light RL toward the light modulator 400R.

The field lens 300G is disposed in the optical path of the green light GL output from dichroic mirror 220. The field lens 300G aligns the traveling directions of the incident green light GL in a peripheral region thereof and having an illuminance lower than a predetermined illuminance with one another in the plane that intersects with the optical axis of the green light GL to suppress a decrease in the amount of light in the peripheral region, and outputs the green light GL toward the light modulator 400G. The field lens 300B is disposed in the optical path of the blue light BL output from the total reflection mirror 250. The field lens 300B aligns the traveling directions of the incident blue light BL in a peripheral region thereof and having an illuminance lower than a predetermined illuminance with one another in the plane that intersects with the optical axis of the blue light BL to suppress a decrease in the amount of light in the peripheral region, and outputs the blue light BL toward the light modulator 400B.

The light modulator 400R is disposed in the optical path of the red light RL reflected off the total reflection mirror 230 and output from the field lens 300R. The light modulator 400R modulates the incident red light RL in accordance with image information input from an image output apparatus that is not shown to convert the red light RL into red image light and outputs the red image light toward the light combining system 500. The image output apparatus is, for example, a personal computer or a portable terminal instrument.

The light modulator 400G is disposed in the optical path of the green light GL reflected off the dichroic mirror 220 and output from the field lens 300G. The light modulator 400G modulates the incident green light GL in accordance with image information input from the image output apparatus, which is not shown, to convert the green light GL into green image light and outputs the green image light toward the light combining system 500.

The light modulator 400B is disposed in the optical path of the blue light BL reflected off the total reflection mirror 250 and output from the field lens 300B. The light modulator 400B modulates the incident blue light BL in accordance with image information input from the image output apparatus, which is not shown, to convert the blue light BL into blue image light and outputs the blue image light toward the light combining system 500.

The light modulators 400R, 400G, and 400B are each, for example, a transmissive liquid crystal panel. Polarizers are disposed at light-incident-side and light-exiting-side regions of each of the liquid crystal panels. That is, the light modulators 400R, 400G, and 400B each include a light-incident-side polarizer, a liquid crystal panel, and a light-exiting-side polarizer that are sequentially arranged from the light incident side toward the light exiting side along the optical path of the incident color light.

The light-incident-side polarizers of the light modulators 400B, 400G, and 400R are disposed in the optical paths of the red light RL, the green light GL, and the blue light BL output from the field lenses 300R, 300G, and 300B. The light-incident-side polarizers each output a predetermined polarized component of the incident color light and blocks components of the color light other than the predetermined polarized component. The predetermined polarized light is, for example, P-polarized color light incident on the light-incident-side polarizer and having a vibration plane parallel to the light incident surface of the light-incident-side polarizer. The light-incident-side polarizer is an absorptive or reflective polarizer having a transmission axis corresponding to the predetermined polarized light. To suppress light returning from the light-incident-side polarizers to the field lenses 300R, 300G, and 300B and stray light, the light-incident-side polarizers are each preferably an absorptive polarizer.

The liquid crystal panels of the light modulators 400B, 400G, and 400R each have a display region and a peripheral region around the display region in a plane that intersects with the optical axis of the incident color light. The display region is provided with multiple pixels arranged two-dimensionally in a plane that intersects with the optical axis of the color light incident on the liquid crystal panel.

The liquid crystal panel of each of the light modulators 400B, 400G, and 400R includes a counter substrate, a liquid crystal layer, and an element substrate that are not shown but are sequentially arranged along the traveling direction of the color light. Counter electrodes and various wires for the multiple pixels are formed at the plate surface of the counter substrate that faces the liquid crystal layer in the display region. Multiple element electrodes, switching elements, and various wires corresponding to the multiple counter electrodes are formed at the plate surface of the element substrate that faces the liquid crystal layer in the display region. The switching elements are each, for example, a polysilicon thin film transistor (TFT).

The pixels of the liquid crystal panel of each of the light modulators 400B, 400G, and 400R each modulate the vibration direction of the corresponding one of the incident red light RL, green light GL, and blue light BL with the aid of the operation of the switching element according to an electric signal corresponding to the aforementioned image information on the color light. The light modulators 400R, 400G, and 400B generate the red image light, the green image light, and the blue image light with the aid of the aforementioned operation of the switching elements.

The light-exiting-side polarizers of the light modulators 400B, 400G, and 400R are disposed in optical paths of the red image light, the green image light, and the blue image light output from the liquid crystal panels disposed in correspondence with the respective multiple types of color light. The light-exiting-side polarizers each output a predetermined polarized component of the incident image light and blocks components of the image light other than the predetermined polarized component. The predetermined polarized light is, for example, P-polarized light having a vibration plane of the color light incident on the light-exiting-side polarizer is parallel to the light incident surface of the light-exiting-side polarizer. The light-exiting-side polarizer is an absorptive or reflective polarizer having a transmission axis corresponding to the predetermined polarized light. To suppress light returning from the light-exiting-side polarizers to the liquid crystal panels and stray light, the light-exiting-side polarizers are each preferably an absorptive polarizer.

The light combining system 500 is disposed in a region where the optical path of the red image light output from the light-exiting-side polarizer of the light modulator 400R, the optical path of the green image light output from the light-exiting-side polarizer of the light modulator 400G, and the optical path of the blue image light output from the light-exiting-side polarizer of the light modulator 400B intersect with each other. The light combining system 500 combines the three types of incident color image light with one another and outputs the generated full-color image light toward the projection system 600.

The light combining system 500 is configured, for example, with a cross dichroic prism. The cross dichroic prism includes four right-angle prisms and two reflection films, the reflection films not shown, and forms a cuboid. The reflection films are each configured, for example, with a dielectric multilayer film. The cross dichroic prism has three light incident surfaces on which the three types of color image light are incident, a light exiting surface via which the full-color image light exits, a first reflection surface, and a second reflection surface. The three light incident surfaces of the cross dichroic prism constitute three side surfaces of the cuboid and face the light exiting surfaces of the light-exiting-side polarizers of the light modulators 400B, 400G, and 400R. The light exiting surface of the cross dichroic prism constitutes the remaining one side surface of the cuboid and faces the light incident surface of the projection system 600. The first reflection surface is located along one diagonal line in the plan view of the cuboid, and is disposed so as to incline by an angle of 45° with respect to the light incident surface of the cross dichroic prism that faces the light exiting surface of the light-exiting-side polarizer of the light modulator 400B, and the light exiting surface of the cross dichroic prism. The first reflection surface transmits the incident red image light and green image light and reflects the incident blue image light. The second reflection surface is located along the other diagonal line in the plan view of the cuboid, and is disposed so as to incline by the angle of 45° with respect to the light incident surface of the cross dichroic prism that faces the light exiting surface of the light-exiting-side polarizer of the light modulator 400R, and the light exiting surface of the cross dichroic prism. The second reflection surface transmits the incident red image light and reflects the incident green image light and blue image light.

The red image light having exited via the light exiting surface of the light-exiting-side polarizer of the light modulator 400R enters the cross dichroic prism, passes through a portion of the first reflection surface, and is reflected off the second reflection surface toward the light exiting surface. The green image light having exited via the light exiting surface of the light-exiting-side polarizer of the light modulator 400G enters the cross dichroic prism, passes through the first and second reflection surfaces, and travels toward the light exiting surface. The blue image light having exited via the light exiting surface of the light-exiting-side polarizer of the light modulator 400B enters the cross dichroic prism, passes through a portion of the second reflection surface, and is reflected off the first reflection surface toward the light exiting surface. The red image light having been reflected off the second reflection surface, the green image light having passed through the first and second reflection surfaces, and the blue image light having been reflected off the first reflection surface are combined with one another to generate the full-color image light.

The projection system 600 is disposed in the optical path of the image light output from the light combining system 500. The projection system 600 projects the incident image light onto the screen SCR, enlarges images transmitted from an image forming apparatus that is not shown to the light modulators 400B, 400G, and 400R, and displays the enlarged images on the screen SCR. The projection system 600 are configured with one or more optical lenses. Examples of the optical lenses may include a plano-convex lens, a plano-concave lens, a biconvex lens, a biconcave lens, a meniscus lens, an aspherical lens, and a freeform surface lens.

### Illuminator

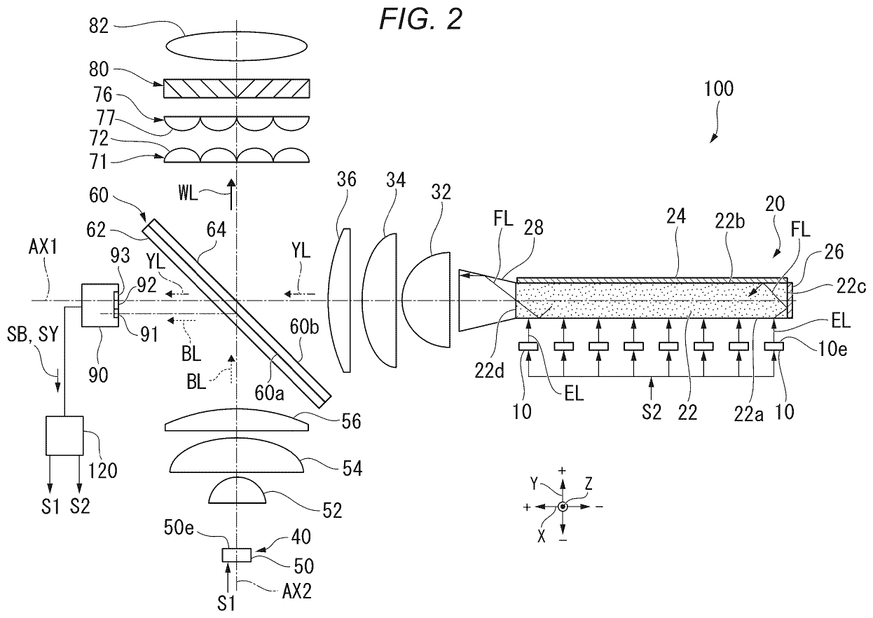

FIG. 2 is a schematic view showing the configuration of the illuminator 100 according to the first embodiment. The illuminator 100 includes a light source 40, optical lenses 52, 54, and 56, a light source 20, optical lenses 32, 34, and 36, a light combiner 60, a light receiving sensor 90, a first lens array 71, a second lens array 76, a polarization converter 80, a superimposing lens 82, and a controller 120, as shown in FIG. 2.

The light source 40 includes a light emitter 50. The light emitter 50 is disposed at a position shifted toward the +X side and the −Y side from the light source 20 and the optical lenses 32, 34, and 36, and overlaps with the light source 20 and the optical lenses 32, 34, and 36 in the Z direction. The light source 40 corresponds to a first light source.

The light emitter 50 emits the blue light BL via a light emitting surface 50e toward the +Y side along the Y direction and an optical axis AX2. The blue light BL emitted from the light emitter 50 corresponds to first light. The optical axis AX2 of the blue light BL emitted from the light emitter 50 is perpendicular to an optical axis AX1 of fluorescence FL output from the light source 20. The light emitting surface 50e of the light emitter 50 is an end surface of the light emitter 50 that faces the +Y side and extends substantially parallel to the XZ plane. A lens, a diffuser, or any other optical element that is not shown may be disposed on the +Y side of the light emitter 50. A blue wavelength band of the blue light BL emitted from the light emitter 50 differs from a yellow wavelength band and corresponds to a first wavelength band. The blue wavelength band of the blue light BL emitted from the light emitter 50 is the same blue wavelength band of the blue light BL that enters the color separation system 200 described with reference to FIG. 1, for example, a wavelength band from 400 nm to 470 nm. The light emitter 50 is, for example, an LED that emits the blue light BL. The blue light BL emitted from the light emitter 50 is non-polarized light and randomly polarized light.

The light emitter 50 may be configured with multiple light emitters 50 the number of which is appropriately determined in accordance with the amount of the blue light BL required for the projector 1000, the color balance of an image projected by the projector 1000, and other factors. When the illuminator 100 includes multiple light emitters 50, the multiple light emitters 50 are arranged, for example, at intervals in a region of an XZ plane that is not shown but spreads around the optical axis AX2 of the blue light BL.

The optical lenses 52, 54, and 56 are disposed in the optical path of the blue light BL output from the light source 40, are disposed at positions shifted toward the +Y side from the light source 40, and overlap with the light source 40 in the X and Z directions, as shown in FIG. 2. The optical lenses 52, 54, and 56 are sequentially arranged at intervals from the −Y side toward the +Y side along the Y direction. The optical axis of the blue light BL passing through the optical lenses 52, 54, and 56 is parallel to the optical axis AX2 of the blue light BL output from the light source 40, and coincides with the optical axis AX2 in the form of a straight line. The optical lenses 52, 54, and 56 parallelize the blue light BL output from the light source 40 along the Y direction. That is, the blue light BL parallel to the Y direction exits via the +Y-side light exiting surface of the optical lens 56.

The light incident surfaces of the optical lenses 52, 54, and 56 are each a planar surface parallel to the XZ plane. The light exiting surfaces of the optical lenses 52, 54, and 56 are each a convex curved surface protruding toward the +Y side. That is, the optical lenses 52, 54, and 56 are each a plano-convex lens having a +Y-side convex curved surface. At least one of the optical lenses 52, 54, and 56 may be any lens that is not a plano-convex lens but can parallelize the blue light BL along the Y direction, such as a biconvex lens, a biconcave lens, a meniscus lens, an aspherical lens, and a freeform surface lens. One or two of the optical lenses 52, 54, and 56 may be omitted, or other optical lenses may be added to the optical lenses 52, 54, and 56 as long as the blue light BL can be parallelized along the Y direction.

The light source 20 includes a wavelength converting member 22, multiple light emitters 10, mirrors 24 and 26, and an angle converting member 28. The light source 20 corresponds to a second light source.

The wavelength converting member 22 is formed in an elongated quadrangular columnar shape, and has four side surfaces including side surfaces 22a and 22b, and two end surfaces 22c and 22d. In the following description about the illuminator 100, the direction in which the wavelength converting member 22 extends is called an X direction, one direction perpendicular to the X direction is called a Y direction, and the direction perpendicular to the X and Y directions is called a Z direction. One side in the X direction is called a −X side, and the other side in the X direction is called a +X side. One side in the Y direction is called a −Y side, and the other side in the Y direction is called a +Y side. One side in the Z direction is called a −Z side, and the other side in the Z direction is called a +Z side.

The edges of the wavelength converting member 22 that are parallel to the X direction are longer than the edges of the wavelength converting member 22 that are parallel to the Y direction and the edges thereof that are parallel to the Z direction. The edges parallel to the Y direction and the edges parallel to the Z direction of the wavelength converting member 22 have the same length. The side surfaces 22a and 22b of the wavelength converting member 22 extend in parallel to the XZ plane containing the X and Z directions, and each have a rectangular shape having long edges parallel to the X direction. The side surface 22a is located at a position shifted toward the −Y side from the side surface 22b. The end surfaces 22c and 22d of the wavelength converting member 22 extend in parallel to the YZ plane containing the Y and Z directions, and each have a square shape. The end surface 22c is located at a position shifted toward the −X side from the end surface 22d.

The wavelength converting member 22 contains a phosphor, and emits the fluorescence FL when irradiated with excitation light EL. That is, the wavelength converting member 22 converts the incident excitation light EL into the fluorescence FL having a wavelength band different from the wavelength band of the excitation light EL. In the present embodiment, the wavelength converting member 22 converts the excitation light EL having a blue wavelength band into the fluorescence FL having a yellow wavelength band. The yellow wavelength band corresponds to a second wavelength band and contains the same green wavelength band of the green light GL and the same red wavelength band of the red light RL, which enter the color separation system 200 described with reference to FIG. 1. The green wavelength band is a wavelength band visually recognized as green in the visible wavelength band, and is, for example, a wavelength band from 490 nm to 600 nm. The red wavelength band is a wavelength band visually recognized as red in the visible wavelength band, and is, for example, a wavelength band from 600 nm to 740 nm.

The wavelength converting member 22 contains a ceramic phosphor configured with a polycrystalline phosphor that converts the excitation light EL in terms of wavelength into the fluorescence FL. Specifically, the material of the wavelength converting member 22 is, for example, YAG: Ce containing an yttrium-aluminum-garnet-based (YAG-based) phosphor and cerium (Ce) as an activator. The wavelength converting member 22 is made, for example, of a material produced by mixing raw powder materials containing yttrium oxide (Y₂O₃), aluminum oxide (Al₂O₃), cerium oxide (CeO₃), and other constituent elements with one another and causing the mixture to go through a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method.

Note that the wavelength converting member 22 may contain a single crystal phosphor that converts the excitation light EL in terms of wavelength into the fluorescence FL in place of the polycrystalline phosphor described above. The wavelength converting member 22 may instead be made of fluorescent glass that converts the excitation light EL in terms of wavelength into the fluorescence FL. The wavelength converting member 22 may still instead be configured with a binder which is made of glass or resin and in which a large number of phosphor particles are dispersed, and may convert the excitation light EL in terms of wavelength into the fluorescence FL.

The multiple light emitters 10 are disposed at the same position in the Y direction along an XZ plane shifted toward the −Y side from the side surface 22a of the wavelength converting member 22, are disposed at intervals in the X direction in the XZ plane but at the same position in the Z direction, as shown in FIG. 2. The multiple light emitters 10 are supported by a substrate, a support member, or any other element that is not shown but is provided, for example, with wires that supply the light emitters 10, for example, with electric signals.

The light emitters 10 each emit the excitation light EL via a light emitting surface 10e toward the +Y side along the Y direction. The light emitting surface 10e of each of the light emitters 10 is a +Y-side end surface extending substantially in parallel to the XZ plane, and faces the side surface 22a of the wavelength converting member 22. A lens, a diffuser, or any other optical element that is not shown may be disposed between the light emitters 10 and the wavelength converting member 22 in the Y direction. The blue wavelength band of the excitation light EL is a wavelength band over which the wavelength converting member 22 can be excited to emit the fluorescence FL as described above, and is, for example, a wavelength band from 400 nm to 480 nm. The peak wavelength of the excitation light EL is, for example, 445 nm, and is equal to the wavelength at which the wavelength converting member 22 is excited. The light emitters 10 are each, for example, an LED that emits the excitation light EL. The excitation light EL emitted from each of the light emitters 10 is non-polarized light and randomly polarized light.

When the excitation light EL emitted from each of the light emitters 10 enters the wavelength converting member 22 via the side surface 22a thereof, the phosphor in the wavelength converting member 22 is excited, and the fluorescence FL is emitted in many directions from light emitting points created in the wavelength converting member 22. The fluorescence FL emitted from the phosphor in the wavelength converting member 22 is repeatedly totally reflected off the side surfaces 22a and 22b and the side surfaces extending in parallel to the XY plane containing the X and Y directions, and travels toward the end surfaces 22c and 22d. The wavelength converting member 22 functions as a light guide member that guides the fluorescence FL. The mirror 24 is disposed on the +Y side of the side surface 22b of the wavelength converting member 22 and is in contact with the side surface 22b. The mirror 24 reflects part of the excitation light EL which enters the wavelength converting member 22 via the side surface 22a, and which travels through the interior of the wavelength converting member 22 and reaches the end surface 22c from the −Y side. The excitation light EL reflected off the mirror 24 at the side surface 22b is reused to excite the wavelength converting member 22. The mirror 24 may reflect the fluorescence FL guided through the interior of the wavelength converting member 22 and incident on the side surface 22b from the −Y side. The mirror 24 is configured, for example, with a dielectric multilayer film or a metal thin film formed separately from the wavelength converting member 22, and is directly formed on the +Y side of the side surface 22b.

Note that when the amount of the excitation light EL that enters the wavelength converting member 22 via the side surface 22a and can exit via the side surface 22b toward the +Y side is small, the mirror 24 may be omitted.

The mirror 26 is disposed on the −X side of the end surface 22c of the wavelength converting member 22 and is in contact with the end surface 22c. The mirror 26 reflects the fluorescence FL guided through the interior of the wavelength converting member 22 and reaching the end surface 22c from the +X side. The fluorescence FL reflected off the mirror 26 at the end surface 22c is guided again through the interior of the wavelength converting member 22 and travels toward the end surface 22d. The mirror 26 is configured, for example, with a dielectric multilayer film or a metal thin film formed separately from the wavelength converting member 22, and is directly formed on the −X side of the end surface 22c. Note that the mirror 26 may include a substrate made, for example, of glass and a reflection film such as a dielectric multilayer film or a metal film formed at one surface of the substrate.

The angle converting member 28 is disposed on the +X side of the end surface 22d of the wavelength converting member 22. The angle converting member 28 is formed, for example, in a truncated quadrangular pyramidal shape. The angle converting member 28 has a −X-side end surface, a +X-side end surface, and four side surfaces. The fluorescence FL guided from the −X side to the end surface 22d of the wavelength converting member 22 and exiting via the end surface 22d is incident on the −X-side end surface of the angle converting member 28. The fluorescence FL exits as yellow light YL via the +X-side end surface of the angle converting member 28.

At least part of the fluorescence FL output via the end surface 22d of the wavelength converting member 22 toward +X side at a wide angle around the X direction is totally reflected off the four side surfaces of the angle converting member 28 toward the +X-side end surface of the angle converting member 28. The optical axis AX1 of the fluorescence FL in the angle converting member 28 is parallel to the X direction. The cross section of the angle converting member 28 that is perpendicular to the optical axis AX1 widens as the angle converting member 28 extends from the −X-side end surface toward the +X-side end surface. That is, the +X-side end surface of the angle converting member 28 is larger than the −X side-end surface thereof.

The fluorescence FL having entered the angle converting member 28 changes its orientation while propagating through the interior of the angle converting member 28 in such a way that the orientation of the fluorescence FL approaches the direction parallel to the optical axis AX1 whenever the fluorescence FL is totally reflected off the side surfaces as described above. The angle converting member 28 converts the exiting angle distribution of the fluorescence FL output via the end surface 22d of the wavelength converting member 22. Specifically, since the etendue of light specified by the product of the area of a region from which light exits and the solid angle, that is, the largest exiting angle of the light is preserved, the etendue of the fluorescence FL is preserved before the fluorescence FL enters the angle converting member 28 and after the fluorescence FL exits out of the angle converting member 28. As described above, since the area of the +X-side end surface of the angle converting member 28 is greater than the area of the −X-side end surface thereof, the angle converting member 28 causes the largest exiting angle of the fluorescence FL exiting via the +X-side end surface to be smaller than the largest incident angle of the fluorescence FL incident on the −X-side end surface to preserve the etendue.

The −X-side end surface of the angle converting member 28 faces the end surface 22d of the wavelength converting member 22 and is fixed to the wavelength converting member 22 via an optical adhesive that is not shown. That is, the angle converting member 28 and the wavelength converting member 22 are coupled to each other in the X direction via the optical adhesive, and no gap is provided between the wavelength converting member 22 and the angle converting member 28. The angle converting member 28 is made of a transparent material such as optical glass. The refractive index of the angle converting member 28 is preferably close to the refractive index of the wavelength converting member 22.

Noted that the angle converting member 28 may be configured with a compound parabolic concentrator (CPC) in place of the truncated quadrangular pyramidal member described above and shown in FIG. 2. The angle converting member 28 may be omitted as long as the etendue of the fluorescence FL output from the wavelength converting member 22 falls within a certain condition.

The fluorescence FL exits along the +X direction as the yellow light YL via the +X-side end surface of the angle converting member 28. The yellow light YL output from the light source 20 is non-polarized light, for example, randomly polarized light, and corresponds to second light.

The optical lenses 32, 34, and 36 are disposed in the optical path of the fluorescence FL output from the light source 20, are disposed at positions shifted toward the +X side from the light source 20, and overlap with the light source 20 in the Y and Z directions. The optical lenses 32, 34, and 36 are sequentially arranged at intervals from the −X side toward the +X side along the X direction. The optical axis of the fluorescence FL passing through the optical lenses 32, 34, and 36 is parallel to the optical axis AX1 of the fluorescence FL output from the light source 20, and coincides with the optical axis AX1 in the form of a straight line. The optical lenses 32, 34, and 36 parallelize the fluorescence FL output from the light source 20 along the X direction. That is, the fluorescence FL, that is, the yellow light YL, which are parallel to the X direction, exits via the +X-side light exiting surface of the optical lens 36.

The light incident surface of each of the optical lenses 32, 34, and 36 is a planar surface parallel to the YZ plane. The light exiting surfaces of the optical lenses 32, 34, and 36 are each a convex curved surface protruding toward the +X side. That is, the optical lenses 32, 34, and 36 are each a plano-convex lens having a +X-side convex curved surface. At least one of the optical lenses 32, 34, and 36 may be any lens that is not a plano-convex lens but can parallelize the fluorescence FL along the X direction, such as a biconvex lens, a biconcave lens, a meniscus lens, an aspherical lens, and a freeform surface lens. One or two of the optical lenses 32, 34, and 36 may be omitted, or other optical lenses may be added to the optical lenses 32, 34, and 36 as long as the fluorescence FL can be parallelized along the X direction.

The optical axes AX1 and AX2 intersect with each other at a predetermined position shifted toward the +X side from the optical lens 36 and toward the +Y side from the optical lens 56. The light combiner 60 contains the predetermined position, where the optical axes AX1 and AX2 intersect with each other, and is disposed in a region where the yellow light YL output from the optical lens 36 toward the +X side along the X direction and the blue light BL output from the optical lens 56 toward the +Y side along the Y direction are superimposed on each other. The light combiner 60 includes a substrate 62 and a reflection film 64, and has reflection surfaces 60a and 60b.

The substrate 62 is made of a material that transmits light having the visible wavelength band and is transparent to the light having the visible wavelength band. The plate surfaces of the substrate 62 incline by 45° with respect to the Y and X directions and incline by 45° with respect to the YZ and XZ planes when viewed along the Z direction. The plate surfaces of the substrate 62 extend from the −Y side toward the +Y side as they extend from the −X side toward the +X side. The substrate 62 and the reflection film 64 have sizes in the X direction that are approximately equal to the size of the blue light BL in the X direction, which is incident on the reflection film 64 from the −Y side through the substrate 62, and each have an appropriate margin at the outer circumference. Similarly, the substrate 62 and the reflection film 64 have sizes in the Y direction that are approximately equal to the size of the yellow light YL in the Y direction, which is incident on the reflection film 64 from the −X side, and each have an appropriate margin at the outer circumference. The substrate 62 and the reflection film 64 have sizes in the Z direction that are approximately equal to the size of the larger one of the yellow light YL in the Z direction, which is incident on the reflection film 64 from the −X side, and the blue light BL in the Z direction, which is incident on the reflection film 64 from the −Y side through the substrate 62, and each have an appropriate margin at the outer circumference.

The reflection film 64 is disposed at the +Y-side surface of the substrate 62 of the light combiner 60, and is in contact with the +Y-side plate surface of the substrate 62. The reflection film 64 reflects part of the yellow light YL incident from the −X side along the X direction at the reflection surface 60b toward the +Y side along the Y direction, and transmits at least part of the remainder of the yellow light YL. The reflection film 64 transmits part of the blue light BL incident from the −Y side along the Y direction, and reflects at least part of the remainder of the blue light BL at the reflection surface 60a toward the +X side along the X direction. The light combiner 60 combines the blue light BL passing through the reflection film 64 and the yellow light YL reflected off the reflection film 64 with each other to generate the white light WL, that is, the illumination light.

The reflection film 64 is, for example, a yellow reflective dichroic mirror (YDM), and is configured with a dielectric multilayer film. The transmittance and reflectance of the reflection film 64 in each of the blue wavelength band and the yellow wavelength band are controlled with high precision by adjusting conditions such as a difference in refractive index between low-refractive-index layers and high-refractive-index layers that constitute the dielectric multilayer film, the layer thickness of each of the low-refractive-index layers, the layer thickness of each of the high-refractive-index layers, and the number of layers.

The reflectance of the reflection film 64 in the blue wavelength band is at least higher than 0%, but is lower than the transmittance of the reflection film 64 in the blue wavelength band. The reflectance of the reflection film 64 in the blue wavelength band is preferably higher than or equal to 0.01% but lower than or equal to 10.00%, more preferably, higher than or equal to 1.0% but lower than or equal to 5.0%. In the case described above, the transmittance of the reflection film in the blue wavelength band is higher than or equal to about 90.0% but lower than or equal to about 99.0%. The transmittance of the reflection film 64 in the yellow wavelength band is at least higher than 0%, but is lower than the reflectance of the reflection film 64 in the yellow wavelength band. The transmittance of the reflection film 64 in the yellow wavelength band is preferably higher than or equal to 0.01% but lower than or equal to 10.00%, more preferably, higher than or equal to 1.0% but lower than or equal to 5.0%. In the case described above, the reflectance of the reflection film in the yellow wavelength band is higher than or equal to about 90.0% but lower than or equal to about 99.0%. Accordingly, the amount of the white light WL output from the illuminator 100, that is, the illumination light is secured, and the light receiving sensor 90 sufficiently receives information on the amount of each of the blue light BL and the yellow light YL in the white light WL.

The lower limit of the reflectance of the reflection film 64 in the blue wavelength band is determined by the minimum ratio of the amount of the blue light BL that can be detected by a detector 91 of the light receiving sensor 90 and clearly distinguished from the background and noise to the amount of the blue light BL that enters the light combiner 60. Similarly, the lower limit of the transmittance of the reflection film 64 in the yellow wavelength band is determined by the minimum ratio of the amount of the yellow light YL that can be detected by the detector 91 of the light receiving sensor 90 and clearly distinguished from the background and noise to the amount of the yellow light YL that enters the light combiner 60. Note that when the reflectance of the reflection film 64 in the blue wavelength band exceeds the upper limit, the white light WL output from the illuminator 100 is lost by an excessively large amount. When the transmittance of the reflection film 64 in the yellow wavelength band exceeds the upper limit, the white light WL output from the illuminator 100 is also lost by an excessively large amount.

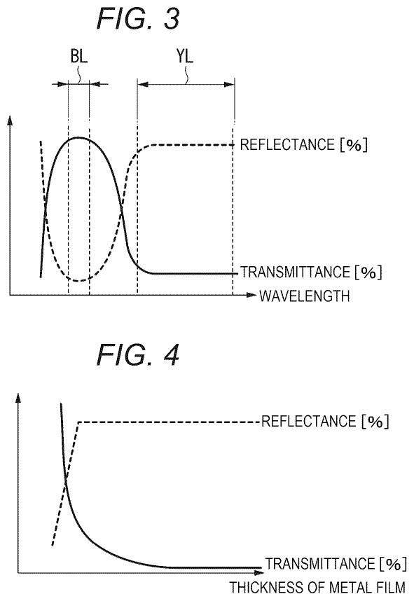

FIG. 3 is a diagrammatic view showing the dependence of the color light transmittance and reflectance of the reflection film 64, which is configured with a YDM, on the wavelength. There is almost no internal absorption in the substrate 62 and the reflection film 64, so that the sum of the color light transmittance and the reflectance of the reflection film 64 can be regarded as one, that is, 100%, as shown in FIG. 3. The transmittance of the reflection film 64 for the blue light BL and the reflectance of the reflection film 64 for the yellow light YL are controlled with high precision when the reflection film 64 is manufactured. That is, since the reflection film 64 is configured with a YDM, the color light transmittance proportional to the thickness of each layer that constitutes the dielectric multilayer film as the YDM is controlled with high precision when the reflection film 64 is manufactured. The thus configured reflection film 64 prevents the amounts of the blue light BL and the yellow light YL output from the reflection film 64 toward the light receiving sensor 90 from not falling within a predetermined range, so that the light receiving sensor 90 is produced at an improved yield. Furthermore, the reflectance of the +Y-side surface of the reflection film 64, that is, the reflection surface 60b for the yellow light YL or the blue light BL is measured to accurately determine the transmittance of the −Y-side surface of the substrate 62, that is, the reflection surface 60b for the blue light BL or the yellow light YL by calculation without measurement.

As described above, since there is no internal absorption in the dielectric multilayer film as a YDM, the yellow light YL passes through the dielectric multilayer film by a large amount, that is, a large amount of yellow light YL is incident on the light receiving sensor 90, so that the light receiving sensor 90 outputs a signal having an improved signal-to-noise ratio. The stray light in the illuminator 100 is thus suppressed in a simplified manner.

FIG. 4 is a diagrammatic view showing the dependence of color light transmittance and reflectance on the wavelength in a case where a metal thin film is disposed at the +Y-side plate surface of the substrate 62. In this case, the color light reflectance does not depend on the wavelength but is substantially constant. Even when the thickness of the metal thin film varies, the color light reflectance is constant, but the color light transmittance significantly varies. Within a predetermined range of the thickness of the metal thin film, the color light transmittance drastically as decreases the thickness increases. Therefore, when the metal thin film is disposed at the +Y-side plate surface of the substrate 62, it is difficult to control the thickness of the metal thin film being manufactured and hence the color light transmittance, so that the light receiving sensor is produced at a reduced yield.

The −Y-side surface of the reflection film 64 faces the light exiting surface of the optical lens 56 and the light receiving surface of the light receiving sensor 90, constitutes the reflection surface 60a of the light combiner 60, and corresponds to a first surface. The +Y-side surface of the reflection film 64 faces the light exiting surface of the optical lens 36 and the light incident surface of the first lens array 71, constitutes the reflection surface 60b of the light combiner 60, and corresponds to a second surface.

The light receiving sensor 90 is disposed on the optical axis AX1 and shifted toward the +X side from the light combiner 60, and overlaps with the light source 20 and the light combiner 60 in the Y and Z directions. The light receiving sensor 90 is disposed in the optical path of the blue light BL and the yellow light YL output from the light combiner 60 toward the +X side along the X direction and the optical axis AX1.

The light receiving sensor 90 includes a single multicolor sensor capable of measuring the amounts of multiple kinds of color light, that is, multiple kinds of light having multiple wavelength bands. Specifically, the light receiving sensor 90 includes detectors 91, 92, and 93 capable of detecting multiple kinds of color light having wavelength bands different from each other. The detector 91 detects the optical intensity or the amount of the incident blue light BL. The detector 92 detects the optical intensity or the amount of the green light GL out of the incident yellow light YL. The detector 93 detects the optical intensity or the amount of the red light RL out of the incident yellow light YL. That is, in the illuminator 100, the amount of the blue light BL and the amounts of the green light GL and the red light RL contained in the yellow light YL are measured with the single multicolor sensor.

The light receiving sensor 90 in the present embodiment detects the blue light BL having the blue wavelength band with the single detector 91, and detects the yellow light YL having the yellow wavelength band with the two detectors 92 and 93, as described above. Note that the light receiving sensor 90 may detect the blue light BL with multiple detectors capable of detecting blue light having wavelength bands contained in the blue wavelength band but different from each other. That is, the light receiving sensor 90 may include multiple detectors capable of detecting color light having wavelength bands contained in a single wavelength band but different from each other. A complicated variation in the spectrum of the color light containing the blue light BL and the yellow light YL can thus be detected in the form of a change in an integral value. A multicolor sensor can detect two integral values separately, for example, a result of integration of the optical output over the measurement range of the green light GL, that is, a green light integral value, and a result of integration of the optical output over the measurement range of the red light RL, that is, a red light integral value with the aid, for example, of color filters.

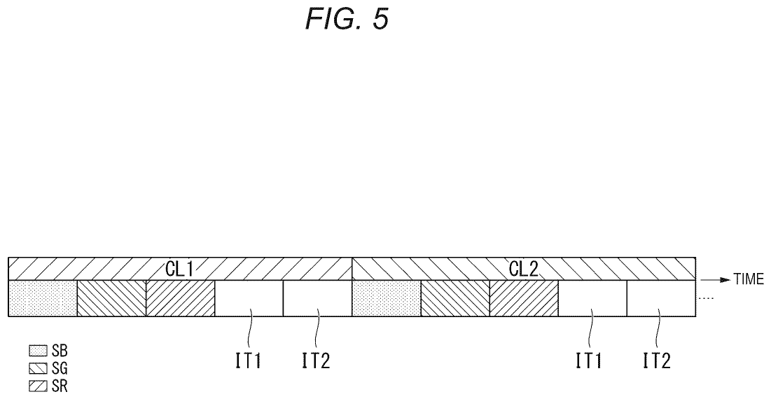

FIG. 5 is a diagrammatic view showing an example of an electric signal, that is, data output from the light receiving sensor 90. In the light receiving sensor 90, an electric signal SB relating to the amount of the blue light BL detected with the detector 91, an electric signal SG relating to the amount of the green light GL detected with the detector 92, and an electric signal SR relating to the amount of the red light RL detected with the detector 93 are continuously output in time series toward the controller 120. In the light receiving sensor 90, there is no waiting period between the electric signals SB and SG output in a single set and between the electric signals SG and SR output in the single set, as shown in FIG. 5. Assuming that brightness CL1 of the blue light BL and the yellow light YL in a certain set is 100%, brightness CL2 of the blue light BL and the yellow light YL in the next set changes from 100%, for example, to 85%. A data transfer period IT1 and a waiting period IT2, for which the detector is switched to another, occur for the first time between the timing at which the electric signal SR is output and the timing at which the electric signal SB in the next set is output. The period for which the electric signals SB, SG, and SR are transferred in time series is thus minimized.

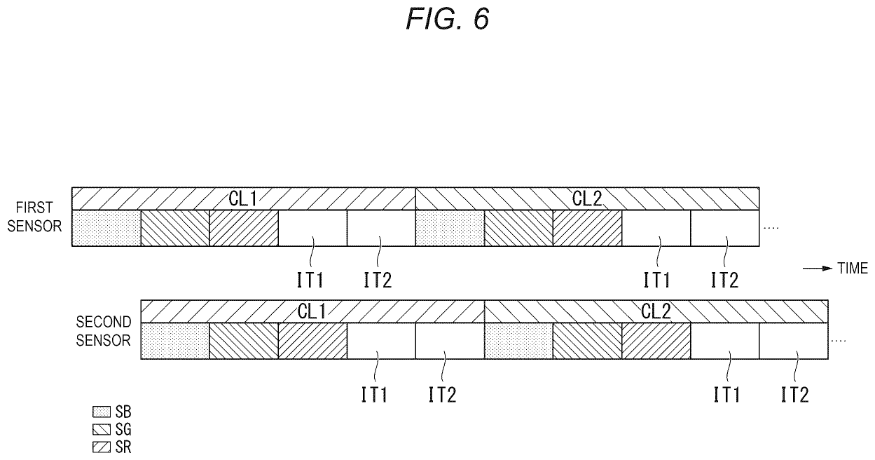

FIG. 6 is a diagrammatic view showing an example of electric signals, that is, data output from a light receiving sensor of related art. The light receiving sensor of related art includes two sensors configured separately from each other. The two sensors include a first sensor that acquires an electric signal relating to the amount of blue light and a second sensor that acquires an electric signal relating to the amount of red light. When the light receiving sensor of related art is used, the period for which the electric signals SB, SG, and SR are transferred in time series is longer than the period required when the light receiving sensor 90 in the present embodiment is used due to the sum of the time difference in the time series between the first sensor and the second sensor shifted from each other, and the transfer period IT1 and the waiting period IT2 in each of the sensors, as shown in FIG. 6.

The first lens array 71 is disposed on the optical axis AX2 at a position shifted toward the +Y side from the light combiner 60, and overlaps with the light source 20 and the light combiner 60 in the X and Z directions. The first lens array 71 is disposed in the optical path of the blue light BL and the yellow light YL output from the light combiner 60 toward the +Y side along the Y direction and the optical axis AX2.

The first: lens array 71 includes multiple microlenses 72. The multiple microlenses 72 are arranged in a matrix in a region of an XZ plane around the optical axis AX2. The multiple microlenses 72 divide the white light WL output from the light combiner 60 and incident from the −Y side into multiple sub-luminous fluxes in the XZ plane. The microlenses 72 viewed along the Y direction each have a quadrangular shape substantially similar to the shape of an image formation region in which the multiple pixels of each of the light modulators 400B, 400R, and 400G are arranged. The sub-luminous fluxes output from the first lens array 71 are thus efficiently incident on the image formation region of each of the light modulators 400B, 400G, and 400R. The microlenses 72 are each, for example, a plano-convex lens having a +Y-side convex curved surface.

The second lens array 76 is disposed at a position shifted toward the +Y side from the first lens array 71 and overlaps with the first lens array 71 in the X and Z directions. The second lens array 76 is disposed in the optical path of the white light WL containing the blue light BL and the yellow light YL output from the first lens array 71 toward the +Y side along the Y direction and the optical axis AX2.

The second lens array 76 includes multiple microlenses 77. The multiple microlenses 77 are arranged in a matrix in a region of an XZ plane around the optical axis AX2, and face the multiple microlenses 72. The multiple microlenses 77 correspond to the multiple microlenses 72 of the first lens array 71. The second lens array 76 cooperates with the superimposing lens 82 to form images of the multiple microlenses 72 of the first lens array 71 in the vicinity of each of the image formation regions of the light modulators 400R, 400G, 400B. The microlenses 77 are each, for example, a plano-convex lens having a −Y-side convex curved surface.

The microlenses 77 of the second lens array 76 each have the same size as each of the microlenses 72 of the first lens array 71 in an XZ plane. The sizes of the microlenses 72 and 77 in the XZ plane may, however, differ from each other. The microlenses 72 of the first lens array 71 and the microlenses 77 of the second lens array 76, which correspond to the microlenses 72, are so located that the optical axes of the color light that enter the two types of microlenses coincide with each other, but may instead be so located that the optical axes deviate from each other.

The polarization converter 80 is disposed at a position shifted toward the +Y side from the second lens array 76 and overlaps with the second lens array 76 in the X and Z directions. The polarization converter 80 is disposed in the optical path of the white light WL output from the second lens array 76 toward the +Y side along the Y direction and the optical axis AX2. The polarization converter 80 converts the polarization direction of the white light WL output from the second lens array 76. Specifically, the polarization converter 80 converts the sub-luminous fluxes that form the white light WL output from the second lens array 76 into linearly polarized light.

The polarization converter 80 includes polarization separating layers, reflection layers, and phase retarding layers, none of which is shown. The polarization separating layers transmit one linearly polarized component of the polarized components contained in the white light WL output from the second lens array 76, and reflect the other linearly polarized component in a direction perpendicular to the optical axis AX2. The reflection layers reflect the other linearly polarized component reflected off the polarization separating layers in the direction parallel to the optical axis AX2. The phase retarding layers convert the other linearly polarized component reflected off the reflection layers into the one linearly polarized component.

The superimposing lens 82 is disposed at a position shifted toward the +Y side from the polarization converter 80 and overlaps with the polarization converter 80 in the X and Z directions. The superimposing lens 82 is, for example, a biconvex lens having-Y-side and the +Y-side convex curved surfaces. Note that the superimposing lens 82 may not be a biconvex lens but may, for example, be a plano-convex lens, a meniscus lens, an aspherical lens, a freeform surface lens.

The first lens array 71, the second lens array 76, and the superimposing lens 82 constitute an optical integration system. The optical integration system functions as a uniform illumination system that homogenizes the optical intensity distribution of the yellow light YL output from the light source 20 and the optical intensity distribution of the blue light BL output from the light source 40 in a plane perpendicular to the optical axis passing through each of the light modulators 400B, 400G, and 400R, which are each an illumination receiving region.

The white light WL output from the superimposing lens 82 travels toward the +Y side along the optical axis AX2 and enters the color separation system 200 shown in FIG. 1.

The controller 120 is electrically coupled to the light receiving sensor 90, and receives the electric signals output from the light receiving sensor 90 in a wired or wireless manner. The controller 120 adjusts the voltage or current supplied to the light emitter 50 of the light source 40 and the voltage or current supplied to the multiple light emitters 10 of the light source 20 in accordance with the intensities of the electric signals output from the light receiving sensor 90 and the relative relationship between the intensities.

Specifically, the controller 120 receives the electric signal SB relating to the optical intensity or the amount of the blue light BL incident on the detector 91 of the light receiving sensor 90, and an electric signal SY relating to the optical intensity or the amount of the yellow light YL incident on the detectors 92 and 93 of the light receiving sensor 90. The controller 120 supplies the light emitter 50 with an electric signal S1 relating to a voltage or a current that realizes an optical intensity or amount required for the blue light BL. The controller 120 supplies the multiple light emitters 10 with the electric signal S1 relating to a voltage or a current that realizes an optical intensity or amount required for the yellow light YL.

For example, when the intensity of the electric signal SB is smaller than a predetermined value, the controller 120 increases the intensity of the electric signal S1 to increase the voltage or current supplied to the light emitter 50 of the light source 40. When the intensity of the electric signal SB is greater than a predetermined value, the controller 120 reduces the intensity of the electric signal S1 to reduce the voltage or current supplied to the light emitter 50 of the light source 40. Similarly, when the intensity of the electric signal SY is smaller than a predetermined value, the controller 120 increases the intensity of an electric signal S2 to increase the voltage or current supplied to the light emitters 10 of the light source 20. When the intensity of the electric signal SY is greater than a predetermined value, the controller 120 reduces the intensity of the electric signal S2 to reduce the voltage or current supplied to the light emitters 10 of the light source 20. The range of the predetermined value of the intensity of the electric signal SB relating to the blue light BL and the range of the predetermined value of the intensity of the electric signal SY relating to the yellow light YL are set in accordance with the color balance of the white light WL, that is, the illumination light, and desired color balance required for an image projected from the projection system 600 of the projector 1000.

The spectrum of the yellow light YL output from the light source 20 varies depending on the period for which and the environment in which the illuminator 100 is used. The yellow light YL contains the green light GL having the green wavelength band contained in the yellow wavelength band and red light RL having the red wavelength band contained in the yellow wavelength band but different from the green wavelength band. The green wavelength band corresponds to a third wavelength band. The green light GL corresponds to third light. The red wavelength band corresponds to a fourth wavelength band. The red light RL corresponds to fourth light.

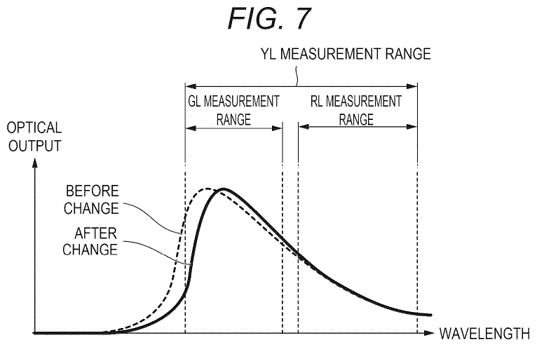

FIG. 7 is a diagrammatic view of the spectrum of the yellow light YL output from the light source 20. For example, out of the green light GL and the red light RL contained in the yellow light YL, only the spectrum of the green light GL within the wavelength range over which the green light GL is measured may change, and the spectrum the red light RL within the wavelength range over which the red light RL is measured may not substantially change, as shown in FIG. 7. The change in the spectrum of the green light GL is detected in the form of an integral value by the detector 92 of the light receiving sensor 90. The light source 20 uses the multiple light emitters 10, which are configured with LEDs arranged along the X direction, as described above. Therefore, the spectrum of the yellow light YL output from the light source 20 is more likely to vary depending on the period for which and the environment in which the illuminator 100 is used than the spectrum of the yellow light YL output from a light source including a fixed or wheel-shaped wavelength converter using laser diodes (LDs) as the light source of the excitation light.

To control the color balance of the illumination light from the illuminator 100 by using the controller 120, the ratio among the optical intensity or the amount of the blue light BL emitted from the light emitter 50 of the light source 40, the optical intensity or the amount of the green light GL output from the light source 20, and the optical intensity or the amount of the red light RL output from the light source 20 is maintained within a fixed range. For example, in related-art control of the color balance of the illumination light, the integration of the optical output within the range over which the yellow light YL is measured, that is, a yellow light integral value is estimated from a red light integral value, and the estimated yellow light integral value and a measured blue light integral value are used in some cases. In this case, when the spectrum of the yellow light YL varies in a complicated manner as shown in FIG. 7, an erroneous estimated yellow light integral value may be provided, so that illumination light having erroneous color balance, that is, unexpected color balance may be output from the illuminator. In contrast, in the illuminator 100 according to the present embodiment, the green light integral value and the red light integral value are separately determined by the detectors 92 and 93. As a result, the color balance of the white light WL output from the superimposing lens 82 disposed as the last element, that is, the illumination light can be accurately adjusted.

The controller 120 is, for example, a computer or a tablet terminal, and is configured with a processor including a built-in program that carries the processes described above. The controller 120 may further have the function of outputting electric signals relating to images to be projected to the light modulators 400B, 400G, and 400R of the projector 1000.

The illuminator 100 according to the first embodiment described above includes the light source (first light source) 40, the light source (second light source) 20, the light combiner 60, and the light receiving sensor 90. The light source 40 outputs the blue light (first light) BL having the blue wavelength band (first wavelength band). The light source 20 outputs the yellow light (second light) YL having the yellow wavelength band (second wavelength band) different from the blue wavelength band. The light combiner 60 has the +Y-side reflection surface (first surface) 60a and the −Y-side reflection surface (second surface) 60b different from the reflection surface 60a. The light receiving sensor 90 receives at least part of the yellow light YL and at least part of the blue light BL. The light combiner 60 includes the substrate 62 and the reflection film 64 configured with a dielectric multilayer film layered on the substrate. The transmittance of the reflection film 64 for the blue light BL having the blue wavelength band is higher than the reflectance of the reflection film 64 for the blue light BL. The reflectance of the reflection film 64 for the blue light BL is greater than 0%. The transmittance of the reflection film 64 for the yellow light YL having the yellow wavelength band is lower than the reflectance of the reflection film 64 for the yellow light YL. The transmittance and reflectance of the reflection film 64 for the blue light BL are greater than 0%. In the illuminator 100 according to the first embodiment, the blue light BL output from the light source 40 is incident on the reflection surface 60a. The yellow light YL output from the light source 20 is incident on the reflection surface 60b. The light receiving sensor 90 receives the blue light (light) BL reflected off the reflection surface 60a out of the blue light BL that enters the light combiner 60, and the yellow light (light) YL having passed through the reflection surface 60b of the light combiner 60 out of the yellow light YL that enters the light combiner 60.

In the illuminator 100 according to the first embodiment, it is not necessary to dispose the light receiving sensor 90 in correspondence with each of the blue light BL and the yellow light YL, so that the illuminator 100 can be reduced in size, configured in a simple manner, and reduced in cost. In addition, in the illuminator 100 according to the first embodiment, it is not necessary to dispose a reflector or a light guide that guides part of the illumination light to the light receiving sensor 90 in the optical path of the white light WL output from the superimposing lens 82 disposed as the last element in the optical path of the color light in the illuminator 100, that is, the illumination light. The illuminator 100 according to the first embodiment can therefore prevent the illumination light from being partially blocked when a reflector or a light guide is disposed.

The illuminator 100 according to the first embodiment further includes the controller 120, which controls the color balance of the white light (light) WL, which is the combination of the blue light BL having been reflected off the reflection film 64 and the yellow light YL having passed through the reflective film 64. The controller 120 is coupled to the light receiving sensor 90 and receives the electric signal relating to the intensity of the blue light BL output from the light receiving sensor 90 and the electric signal relating to the intensity of the yellow light YL output from the light receiving sensor 90.

The illuminator 100 according to the first embodiment can control the color balance of the white light WL, which is the combined light, that is, the illumination light, in accordance with the result of the detection, performed by the light receiving sensor 90, of the intensity of the blue light BL and the intensity of the yellow light YL.

In the illuminator 100 according to the first embodiment, the blue light BL incident on the reflection surface 60a of the light combiner 60 and the yellow light YL incident on the reflection surface 60b of the light combiner 60 each randomly polarized light. The reflection film 64 is a YDM (dichroic mirror).

In the illuminator 100 according to the first embodiment, the white light WL output from the illuminator 100, that is, the illumination light is color light that is the combination of the blue light BL and the yellow light YL, and is randomly polarized light, so that interference noise produced by the illumination light can be reduced.

In the illuminator 100 according to the first embodiment, the light source 40 includes an LED as the light emitter 50. The light source 20 includes LEDs as the light emitters 10.

The illuminator 100 according to the first embodiment can readily produce randomly polarized light in the form of the blue light BL and the yellow light YL.

In the illuminator 100 according to the first embodiment, the reflectance of the reflection film 64 in the blue wavelength band is greater than or equal to 0.01% but smaller than or equal to 10.0%, and the transmittance of the reflection film 64 in the yellow wavelength band greater than or equal to 0.01% but smaller than or equal to 10.0%.

The illuminator 100 according to the first embodiment can secure the amount of the white light WL output from the illuminator 100, that is, the illumination light, and acquire information on the amounts of the blue light BL and the yellow light YL with the light receiving sensor 90.

In the illuminator 100 according to the first embodiment, the light source 20 includes the light emitters 10 and the wavelength conversion member 22. The light emitters 10 each emit the excitation light EL having the blue wavelength band toward the wavelength converting member 22. The wavelength converting member 22 contains a phosphor, and converts the excitation light EL into the fluorescence FL, which is the yellow light YL having the yellow wavelength band. The wavelength converting member 22 has the end surface (first end surface) 22c and the end surface (second end surface) 22d, which are located at sides opposite each other in the X direction (longitudinal direction), and the side surfaces that couple the end surfaces 22c and 22d to each other along the X direction. The end surface 22c is the −X-side end surface of the wavelength converting member 22. The end surface 22d is the +X-side end surface of the wavelength converting member 22. The end surface 22d is disposed at a position closer to the reflection surface 60b of the light combiner 60 than the end surface 22c in the X direction. The yellow light YL exits via the end surface 22d of the wavelength converting member 22.

The illuminator 100 according to the first embodiment can reduce a heat load generated in the wavelength converting member 22, which is elongated along the X direction, when the excitation light EL enters the wavelength converting member 22, so that the durability of the light source 20 can be improved.

In the illuminator 100 according to the first embodiment, the light receiving sensor 90 separately receives the green light (third light) GL having the green wavelength band (third wavelength band) contained in the yellow wavelength band, and the red light (fourth light) RL having the red wavelength band (fourth wavelength band) contained in the yellow wavelength band but different from the green wavelength band.

The illuminator 100 according to the first embodiment can detect a complex variation in the spectrum of at least one of the green light GL and the red light RL contained in the yellow light YL output from the light source 20. As a result, the color balance and other factors of the white light WL output from the illuminator 100, that is, the illumination light can be controlled with high precision in accordance with the variation in the spectrum of at least one of the green light GL and the red light RL.

In the illuminator 100 according to the first embodiment, the light receiving sensor 90 includes the multiple detectors 91, 92, and 93. The multiple detectors 91, 92, and 93 can detect the blue light BL having the blue wavelength band, the green light GL having the green wavelength band, and the red light RL having the red wavelength band, which have colors different from each other. The multiple detectors 91, 92, and 93 continuously output in time series electric signals (data) relating to the amount of the blue light BL, the amount of the green light GL, and the amount of the red light RL detected by the respective detectors.

In the illuminator 100 according to the first embodiment, electric signals relating to the amounts of the multiple types of color light, that is, the amount of the blue light BL, the amount of the green light GL, and the amount of the red light RL are continuously output from an interface in the light receiving sensor 90 configured as a single multicolor sensor. The illuminator 100 according to the first embodiment, which eliminates the need to secure a waiting period required to switch the detector from one of detectors 91, 92, and 93 to another in time series, can shorten the period for which the electric signal relating to the amount of the multiple types of color light is transferred. As a result, the information on the ratio among the amounts of the blue light BL, the green light GL, and the red light RL of the illumination light in the illuminator 100 can be acquired quickly and accurately as compared with the illuminator of related art.

Although not shown, the light source 40 and the light source 20 may be swapped as a variation of the illuminator 100 according to the first embodiment. That is, the light source 40 may output the blue light BL toward the +X side along the X direction and the optical axis AX1. The light source 20 may output the yellow light YL toward the +Y side along the Y direction and the optical axis AX2. In the arrangement and configuration described above, the light source 20 corresponds to the first light source, the yellow light YL corresponds to the first light, and the yellow wavelength band corresponds to the first wavelength band. The light source 40 corresponds to the second light source, the blue light BL corresponds to the second light, and the blue wavelength band corresponds to the second wavelength band. The +Y-side surface of the reflection film 64 of the light combiner 60 constitutes the reflection surface 60a and corresponds to the first surface. The −Y-side surface of the reflection film 64 of the light combiner 60 constitutes the reflection surface 60b and corresponds to the second surface. Even in the apparatus configuration described above, the same effects as those provided by the illuminator 100 according to the first embodiment can be provided.

The projector 1000 according to the first embodiment includes the illuminator 100 described above, the light modulators 400B, 400G, and 400R, and the projection system 600. The light modulators 400B, 400G, and 400R modulate the blue light (color light) BL, the green light (color light) GL, and the red light (color light) RL output from the illuminator 100 in accordance with image information, and output the blue image light, the green image light, and the red image light. The projection system 600 projects the blue image light, the green image light, and the red image light output from the light modulators 400B, 400G, and 400R onto the screen SCR.

The projector 1000 according to the first embodiment can provide a projector including the illuminator 100, which can have a smaller, simpler configuration than the illuminator of related art. In addition, the projector 1000 according to the first embodiment can acquire the information on the intensity and the amount of each of the blue light BL and the yellow light YL contained in the white light WL output from the illuminator 100, that is, the illumination light with high precision.

### Second Embodiment

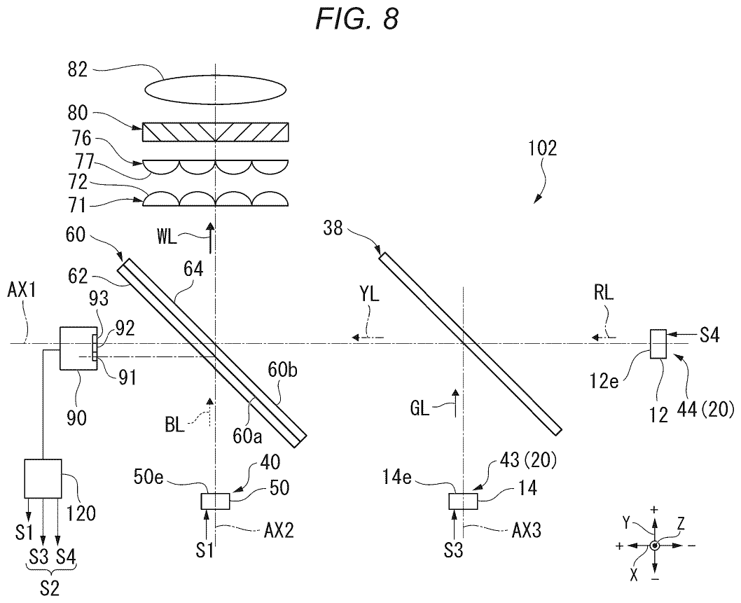

A second embodiment of the present disclosure will next be described with reference to FIG. 8. Note in the second embodiment that the contents common to those in the first embodiment will be omitted, and only contents different from those in the first embodiment will be described. Out of the elements of a projector and an illuminator 102 according to the second embodiment, the elements common to those of the projector 1000 and the illuminator 100 according to the first embodiment have the same reference characters as the elements of the projector 1000 and the illuminator 100, and will not be described in detail.

Although not shown, the projector according to the second embodiment includes the illuminator 102 according to the second embodiment in place of the illuminator 100 according to the first embodiment, and further includes the same configuration as the projector 1000 according to the first embodiment except the illuminator 100.

FIG. 8 schematic is a view showing the configuration of the illuminator 102 according to the second embodiment. The illuminator 102 includes light sources 43 and 44, a dichroic mirror 38, the light combiner 60, the light receiving sensor 90, the first lens array 71, the second lens array 76, the polarization converter 80, the superimposing lens 82, and the controller 120, as shown in FIG. 8. In FIG. 8, the optical lenses 52, 54, and 56 are omitted.

The light sources 43 and 44 and the dichroic mirror 38 in the illuminator 102 constitute a light source that outputs the yellow light YL, as the light source 20 in the illuminator 100.

The light source 43 includes a light emitter 14. The light emitter 14 is disposed at a position shifted toward the −X side from the light source 40 and the optical lenses 52, 54, and 56, and overlaps with the light source 40 in the Y and Z directions. The light source 43 corresponds to a first sub-light source. The light emitter 14 emits the green light GL via a light emitting surface 14e toward the +Y side along the Y direction and an optical axis AX3. The optical axis AX3 is parallel to the optical axis AX2 and is shifted toward the −X side from the optical axis AX2.

The green light GL emitted from the light emitter 14 corresponds to the third light. The light emitting surface 14e of the light emitter 14 is the +Y-side end surface of the light emitter 14 that extends substantially in parallel to the XZ plane. A lens, a diffuser, or any other optical element that is not shown may be disposed on the +Y side of the light emitter 14. The green wavelength band of the green light GL emitted from the light emitter 14 is contained in the yellow wavelength band, is a portion of the yellow wavelength band, and corresponds to the third wavelength band. The green wavelength band of the green light GL emitted from the light emitter 14 is the same green wavelength band of the green light GL that enters the color separation system 200 described with reference to FIG. 1. The light emitter 14 is, for example, an LED that emits the green light GL. The green light GL emitted from the light emitter 14 is non-polarized light and randomly polarized light.

The light emitter 14 may be configured with multiple light emitters 14 the number of which is appropriately determined in accordance with the amount of the green light GL required for the projector 1000, the color balance of an image projected by the projector 1000, and other factors. When the illuminator 102 includes multiple light emitters 14, the multiple light emitters 14 are disposed, for example, at intervals in a region of an XZ plane that is not shown but spreads around the optical axis AX3 of the green light GL.

The light source 44 includes a light emitter 12, as shown in FIG. 8. The light emitter 12 is disposed at a position shifted toward the −X side and the +Y side from the light emitter 14 of the light source 43, is disposed on the optical axis AX1, and overlaps with the light source 43 in the Z direction. The light source 44 corresponds to a second sub-light source. The light emitter 12 emits the red light RL via a light emitting surface 12e toward the +X side along the X direction and the optical axis AX1.

The red light RL emitted from the light emitter 12 corresponds to the fourth light. The light emitting surface 12e of the light emitter 12 is the +X-side end surface of the light emitter 12 that extends substantially in parallel to the YZ plane. A lens, a diffuser, or any other optical element that is not shown may be disposed on the +X side of the light emitter 12. The red wavelength band of the red light RL emitted from the light emitter 12 is contained in the yellow wavelength band, is a portion of the yellow wavelength band, differs from the green wavelength band, and corresponds to the fourth wavelength band. The red wavelength band of the red light RL emitted from the light emitter 12 is the same red wavelength band of the red light RL that enters the color separation system 200 described with reference to FIG. 1. The light emitter 12 is, for example, an LED that emits the red light RL. The red light RL emitted from the light emitter 12 is non-polarized light and randomly polarized light.

The light emitter 12 may be configured with multiple light emitters 12 the number of which is appropriately determined in accordance with the amount of the red light RL required for the projector 1000, the color balance of an image projected by the projector 1000, and other factors. When the illuminator 102 includes multiple light emitters 12, the multiple light emitters 12 are disposed, for example, at intervals in a region of an YZ plane that is not shown but spreads around the optical axis AX1 of the red light RL.

The optical axis AX1 of the red light RL emitted from the light emitter 12 of the light source 44 is perpendicular to the optical axis AX3 of the green light GL, which is emitted from the light emitter 14 of the light source 43, at a predetermined position. The predetermined position is shifted toward the −X side from the position where the optical axes AX1 and AX2 intersect with each other.

The dichroic mirror 38 contains the predetermined position, where the optical axes AX1 and AX3 intersect with each other, and is disposed in a region where the red light RL output from the light source 44 toward the +X side along the X direction and the green light GL output from the light source 43 toward the +Y side along the Y direction are superimposed on each other. The dichroic mirror 38 is a green reflective dichroic mirror (GDM), has a reflection surface, and is configured with a dielectric multilayer film.

The reflection surface of the dichroic mirror 38 transmits the red light RL incident from the −X side along the X direction toward the +X side, and reflects the green light GL incident from the −Y side along the Y direction toward the +X side along the X direction. The reflection surface of the dichroic mirror 38 extends from the −Y side toward the +Y side as it extends from the −X side toward the +X side. The dichroic mirror 38 combines the green light GL reflected thereby and the red light RL passing therethrough with each other to generate the yellow light YL.

In the illuminator 102, the controller 120 supplies the light emitter 14 with an electric signal S3 relating to a voltage or a current that realizes an optical intensity or amount required for the green light GL in place of the electric signal S2, and supplies the light emitter 12 with an electric signal S4 relating to a voltage or a current that realizes an optical intensity or amount required for the red light RL.

In the illuminator 102 according to the second embodiment described above, the light source (second light source) 20 includes the light source (first sub-light source) 43 and the light source (second sub-light source) 44. The light source 43 outputs the green light (third light) GL having the green wavelength band (third wavelength band) contained in the yellow wavelength band. The light source 44 outputs the red light (fourth light) RL having the red wavelength band (fourth wavelength band) contained in the yellow wavelength band but different from the green wavelength band.

In the illuminator 102 according to the second embodiment, in which the three light sources 40, 43, and 44 generate the three types of color light including the blue light BL, the green light GL, and the red light RL, the color gamut of the white light WL output from the superimposing lens 82 disposed as the last element, that is, the illumination light can be expanded.

The illuminator 102 according to the second embodiment can provide the same effects and advantages as those provided by the arrangement and configuration common to those of the illuminator 100 according to the first embodiment.

Although not shown, the light source 43 and the light source 44 may be swapped as a variation of the illuminator 102 according to the second embodiment. That is, the light source 43 may output the green light GL toward the +X side along the X direction and the optical axis AX1. The light source 44 may output the red light RL toward the +Y side along the Y direction and the optical axis AX3. In the arrangement and configuration described above, the reflection surface of the dichroic mirror 38 transmits the green light GL incident from the −X side along the X direction toward the +X side, and reflects the red light RL incident from the −Y side along the Y direction toward the +X side along the X direction. The dichroic mirror 38 combines the green light GL passing therethrough and the red light RL reflected thereby with each other to generate the yellow light YL. According to the arrangement and configuration described above, the same effects and advantages as those provided by the illuminator 102 according to the second embodiment can be provided.

### Third Embodiment

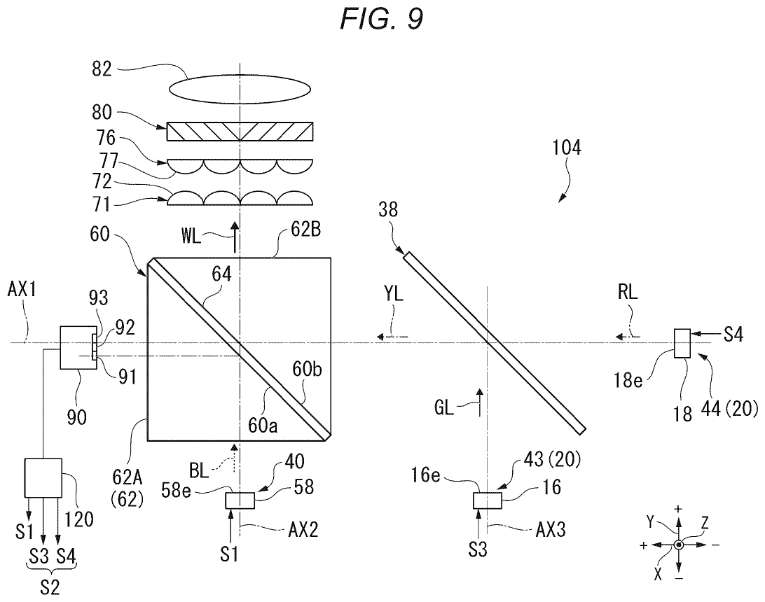

A third embodiment of the present disclosure will next be described with reference to FIG. 9. In the third embodiment, the contents common to those in the first and second embodiments will be omitted, and only contents different from those in the first and second embodiments will be described. Out of the elements of a projector and an illuminator 104 according to the third embodiment, the elements common to those of the projector 1000 and the illuminator 100 according to the first embodiment have the same reference characters as the elements of the projector 1000 and the illuminator 100, and will not be described in detail.

Although not shown, the projector according to the third embodiment includes the illuminator 104 according to the third embodiment in place of the illuminator 100 according to the first embodiment, and further includes the same configuration as the projector 1000 according to the first embodiment except the illuminator 100.

FIG. 9 is a schematic view showing the configuration of the illuminator 104 according to the third embodiment. The illuminator 104 includes the light sources 43 and 44, the dichroic mirror 38, the light combiner 60, the light receiving sensor 90, the first lens array 71, the second lens array 76, the polarization converter 80, the superimposing lens 82, and the controller 120, as the illuminator 102 according to the second embodiment, as shown in FIG. 9. Also in FIG. 9, the optical lenses 52, 54, and 56 are omitted.

The light source 40 includes a light emitter 58 in place of the light emitter 50. The light emitter 58 emits the blue light BL via a light emitting surface 58e toward the +X side along the Y direction and an optical axis AX2. The light emitter 58 is, for example, an LD that emits the blue light BL. The blue light BL emitted from the light emitter 58 is linearly polarized light, for example, P-polarized light. The polarization direction of the blue light BL is parallel to the X direction.

The light source 43 includes a light emitter 16 in place of the light emitter 14. The light emitter 16 emits the green light GL via a light emitting surface 16e toward the +Y side along the Y direction and an optical axis AX3. The light emitter 16 is an LD that emits the green light GL. The light source 44 includes a light emitter 18 in place of the light emitter 12. The light emitter 18 outputs the red light RL via a light emitting surface 18e toward the +X side along the X direction and the optical axis AX1. The light emitter 18 is an LD that emits the red light RL. The green light GL emitted from the light emitter 16 and the red light RL emitted from the light emitter 18 are each linearly polarized light. The yellow light YL as a result of the combination performed by the dichroic mirror 38 is, for example, S-polarized light. The polarization direction of the blue light BL is parallel to the X direction.

The light combiner 60 is, for example, a cube-shaped polarizing beam splitter, and includes two right-angle prisms 62A and 62B and the reflection film 64. The reflection film 64 is disposed at the bonding surface between the inclining surfaces of the two right-angle prisms 62A and 62B. The reflection film 64 is provided at the inclining surface of the right-angle prism 62A, and the right-angle prism 62A functions as a substrate in the light combiner 60.

The right-angle prisms 62A and 62B are made of a material that transmits light having the visible wavelength band and is transparent to the light having the visible wavelength band. The inclining surfaces of the right-angle prisms 62A and 62B each incline by 45° with respect to the Y and X directions and incline by 45° with respect to the YZ and XZ planes when viewed along the Z direction. The inclining surfaces of the right-angle prisms 62A and 62B extend from the −Y side toward the +Y side as they extend from the −X side toward the +X side.

The right-angle prisms 62A and 62B and the reflection film 64 have sizes in the X direction that are approximately equal to the size of the blue light BL in the X direction, which is incident on the reflection film 64 from the −Y side through the right-angle prism 62A, and each have an appropriate margin at the outer circumference. Similarly, the right-angle prisms 62A and 62B and the reflection film 64 have sizes in the Y direction that are approximately equal to the size of the yellow light YL in the Y direction, which is incident on the reflection film 64 from the −X side through the right-angle prism 62B, and each have an appropriate margin at the outer circumference. The right-angle prisms 62A and 62B and the reflection film 64 have sizes in the Z direction that are approximately equal to the size of the larger one of the yellow light YL in the Z direction, which is incident on the reflection film 64 from the −X side through the right-angle prism 62B, and the blue light BL in the Z direction, which is incident on the reflection film 64 from the −Y side through the right-angle prism 62A, and each have an appropriate margin at the outer circumference.

The white light WL as a result of the combination performed by the light combiner 60, that is, the illumination light contains the P-polarized blue light BL and the S-polarized yellow light YL, and enters the first lens array 71 as non-polarize or randomly polarized light. The white light WL converted into linearly polarized light by the polarization converter 80 of the illuminator 104 exits out of the superimposing lens 82, as in the illuminator 100 according to the first embodiment and the illuminator 102 according to the second embodiment.

In the illuminator 104 according to the third embodiment described above, the blue light BL incident on the reflection surface 60a of the light combiner 60 and the yellow light YL incident on the reflection surface 60b are each linearly polarized light. The light combiner 60 is configured, for example, with a cube-shaped polarizing beam splitter. The reflection film 64 of the light combiner 60 is configured with a dielectric multilayer film disposed between the two right-angle prisms 62A and 62B of the cube-shaped polarizing beam splitter.

In the illuminator 104 according to the third embodiment, in accordance with the amounts of shift of the polarization axes of the blue light BL, the green light GL, and the red light RL, which are linearly polarized light, with respect to the orientations of the S-polarization and the P-polarization axes in the polarizing beam splitter, the optical intensities of the multiple types of color light incident on the detectors 91, 92, and 93 of the light receiving sensor 90 can be readily adjusted.

The illuminator 104 according to the third embodiment can provide the same effects and advantages as those provided by the arrangements and configurations common to those of the illuminator 100 according to the first embodiment and the illuminator 102 according to the second embodiment. Furthermore, the variation described with reference to the illuminator 102 according to the second embodiment may be applied to the illuminator 104 according to the third embodiment.

A cube-shaped polarizing beam splitter is presented by way of example as the light combiner 60 in the illuminator 104 according to the third embodiment, and a plate-shaped polarizing beam splitter having a substrate and the reflection film 64 may be used in place of the cube-shaped polarizing beam splitter.

Although not shown, the polarizing beam splitter may be made of a nonlinear optical crystal. A prism made of a birefringent material or a combination of a Glan Taylor prism and a wedge prism may, for example, be used as the light combiner 60 in the illuminator 104 according to the third embodiment. Even when the configuration described above is used, the optical intensities of the multiple types of color light incident on the detectors 91, 92, and 93 of the light receiving sensor 90 can be readily adjusted in accordance with the amounts of shift of the polarization axes of the multiple types of color light with respect to the orientations of the S-polarization and the P-polarization axes in the polarizing beam splitter and the light combiner 60.

Preferable embodiments of the present disclosure have been described above in detail. The present disclosure is, however, not limited to a specific embodiment, and various modifications and changes can be made to the embodiments within the scope of the gist of the present disclosure described in the claims. The configurations of the multiple embodiments and variations of the embodiments may be combined with each other as appropriate.

### Summary of Present Disclosure

The present disclosure will be summarized below in the form of additional remarks.

(Additional remark 1) An illuminator including a first light source configured to output first light having a first wavelength band; a second light source configured to output second light having a second wavelength band different from the first wavelength band; a light combiner having a first surface and a second surface different from the first surface; and a light receiving sensor configured to receive the first light and the second light, wherein the light combiner includes a substrate, and a reflection film layered on the substrate, the reflection film has transmittance higher than reflectance in the first wavelength band, and the reflectance is higher than 0% in the first wavelength band, the reflection film has transmittance lower than the reflectance in the second wavelength band, and the transmittance is higher than 0% in the second wavelength band, the first light is incident on the first surface, the second light is incident on the second surface, and the light receiving sensor is configured to receive the first light reflected off the first surface and the second light passing through the second surface.

The configuration described in Additional remark 1 allows reduction in the size of the illuminator, a simple configuration of the illuminator, and reduction in the overall cost including the manufacturing cost and the installation cost. The configuration according to Additional remark 1 can further prevent the illumination light from being partially blocked when a reflector or a light guide is disposed as in the illuminator or related art.

(Additional remark 2) The illuminator according to Additional remark 1, further including a controller configured to control color balance of combined light containing the first light reflected off the reflection film and the second light passing through the reflection film.

According to the configuration described in Additional remark 2, the color balance of illumination light that is the combined light output from the illuminator can be controlled in accordance with the result of detection, performed by the light receiving sensor, of the intensity of the first light and the intensity of the second light.

(Additional remark 3) The illuminator according to Additional remark 1 or 2, wherein the first light incident on the first surface and the second light incident on the second surface are each randomly polarized light, and the reflection film is a dichroic mirror.

The configuration described in the Additional remark 3 can reduce interference noise produced by illumination light output from the illuminator.

(Additional remark 4) The illuminator according to any of Additional remark 1 to 3, wherein the first and second light sources each include an LED.

According to the configuration described in Additional remark 4, the first and second randomly polarized light can be readily generated.

(Additional remark 5) The illuminator according to any of Additional remarks 1 to 4, wherein the reflectance of the reflection film in the first wavelength band is higher than or equal to 0.01% but lower than or equal to 10.00%, and the transmittance of the reflection film in the second wavelength band is higher than or equal to 0.01% but lower than or equal to 10.00%.

According to the configuration described in Additional remark 5, the amount of the illumination light output from the illuminator can be secured, and information on the intensities or the amounts of the first light and the second light can be acquired by the light receiving sensor.

(Additional remark 6) The illuminator according to any of Additional remarks 1 to 5, wherein the second light source includes a light emitter configured to emit excitation light, and a wavelength converting member containing a phosphor and configured to convert the excitation light into the second light, the wavelength converting member has a first end surface and a second end surface that are located at sides opposite each other in a longitudinal direction, and a side surface configured to couple the first end surface and the second end surface to each other along the longitudinal direction, the second end surface is disposed at a position closer to the second surface than the first end surface in the longitudinal direction, and the second light exits via the second end surface.

According to the configuration described in Additional remark 6, a heat load generated in the elongated wavelength converting member when the excitation light enters the wavelength converting member, so that the durability of the light source can be improved.

(Additional remark 7) The illuminator according to Additional remark 6, wherein the light receiving sensor is configured to receive third light having a third wavelength band contained in the second wavelength band, and fourth light having a fourth wavelength band contained in the second wavelength band but different from the third wavelength band.

According to the configuration described in Additional remark 7, a complicated variation in the spectrum of at least one of the third light and the fourth light contained in the second light output from the second light source can be detected. As a result, the color balance and other factors of the illumination light output from the illuminator can be controlled with high precision in accordance with the variation in the spectrum of at least one of the third light and the fourth light.

(Additional remark 8) The illuminator according to any of Additional remarks 1 to 7, wherein the light receiving sensor includes multiple detectors configured to detect multiple types of color light having wavelength bands different from each other, and the multiple detectors are configured to continuously detect amounts of the multiple types of color light in time series and output data on the detected amounts.

The configuration described in Additional remark 8, which eliminates the need to secure a waiting period required to switch the detector from one of multiple detectors to another, can shorten the period for which an electric signal relating to the intensities of amounts of the multiple types of color light is transferred. As a result, information on the ratio among the amounts of the multiple types of color light contained in the illumination light in the illuminator can be acquired quickly and accurately as compared with the illuminator of related art.

(Additional remark 9) The illuminator according to any of Additional remarks 1 to 8, wherein the second light source includes a first sub-light source configured to output third light having a third wavelength band contained in the second wavelength band, and a second sub-light source configured to output fourth light having a fourth wavelength band contained in the second wavelength band but different from the third wavelength band. According to the configuration described in Additional remark 9, the first light source, the first sub-light source, and the second sub-light source separately produce three types of color light to be combined with one another into the illumination light, the color gamut of the illumination light output from the illuminator can be expanded as compared with a case where only the first and second light sources are used.

(Additional remark 10) A projector including:
the illuminator according to any of Additional remarks 1 to 9; a light modulator configured to modulate color light output from the illuminator in accordance with image information; and a projection system configured to project image light output from the light modulator.

According to the configuration described in Additional remark 10, a projector including an illuminator that can have a smaller, simpler configuration than the illuminator of related art can be provided.

What is claimed is:

1. An illuminator comprising:
a first light source configured to output first light having a first wavelength band;
a second light source configured to output second light having a second wavelength band different from the first wavelength band;
a light combiner having a first surface and a second surface different from the first surface; and
a light receiving sensor configured to receive the first light and the second light,
wherein the light combiner includes
a substrate, and
a reflection film layered on the substrate,
the reflection film has transmittance higher than reflectance in the first wavelength band, and the reflectance is higher than 0% in the first wavelength band,
the reflection film has transmittance lower than the reflectance in the second wavelength band, and the transmittance is higher than 0% in the second wavelength band,
the first light is incident on the first surface,
the second light is incident on the second surface, and
the light receiving sensor is configured to receive the first light reflected off the first surface and the second light passing through the second surface.

2. The illuminator according to claim 1, further comprising
a controller configured to control color balance of combined light containing the first light reflected off the reflection film and the second light passing through the reflection film.

3. The illuminator according to claim 1, wherein
the first light incident on the first surface and the second light incident on the second surface are each randomly polarized light, and
the reflection film is a dichroic mirror.

4. The illuminator according to claim 1, wherein
the first and second light sources each include a light emitting diode.

5. The illuminator according to claim 1, wherein
the reflectance of the reflection film in the first wavelength band is higher than or equal to 0.01% but lower than or equal to 10.00%, and
the transmittance of the reflection film in the second wavelength band is higher than or equal to 0.01% but lower than or equal to 10.00%.

6. The illuminator according to claim 1, wherein
the second light source includes a light emitter configured to emit excitation light, and
a wavelength converting member containing a phosphor and configured to convert the excitation light into the second light,
the wavelength converting member has a first end surface and a second end surface that are located at sides opposite each other in a longitudinal direction, and a side surface configured to couple the first end surface and the second end surface to each other along the longitudinal direction,
the second end surface is disposed at a position closer to the second surface than the first end surface in the longitudinal direction, and
the second light exits via the second end surface.

7. The illuminator according to claim 6, wherein
the light receiving sensor is configured to receive third light having a third wavelength band contained in the second wavelength band, and fourth light having a fourth wavelength band contained in the second wavelength band but different from the third wavelength band.

8. The illuminator according to claim 1, wherein
the light receiving sensor includes multiple detectors configured to detect multiple types of color light having wavelength bands different from each other, and
the multiple detectors are configured to continuously detect amounts of the multiple types of color light in time series and output data on the detected amounts.

9. The illuminator according to claim 1, wherein
the second light source includes a first sub-light source configured to output third light having a third wavelength band contained in the second wavelength band, and a second sub-light source configured to output fourth light having a fourth wavelength band contained in the second wavelength band but different from the third wavelength band.

10. A projector comprising:
the illuminator according to claim 1;
a light modulator configured to modulate color light output from the illuminator in accordance with image information; and
a projection system configured to project image light output from the light modulator.
